(19) United States
(12) Patent Application Publication
(10) Pub. No.: US 2013/0263110 A1
(43) Pub. Date: Oct. 3, 2013

(54) VISUALIZING PROCESS INTEGRATION SCENARIOS ON MOBILE DEVICES

(71) Applicant: Bernhard FIPPEL, Heidelberg (DE)

(72) Inventor: Bernhard FIPPEL, Heidelberg (DE)

(73) Assignee: SAP AG, Walldorf (DE)

(21) Appl. No.: 13/438,388

(22) Filed: Apr. 3, 2012

(51) Int. Cl. G06F 9/44; G06F 15/16

(52) U.S. Cl. 717/173; 717/168; 717/171; 717/172

(57) ABSTRACT

A system and method provide for an application implemented on a mobile device that may visualize process integration scenarios on the device. The application may include a parser to translate the metadata written in a given language into graphical elements. The application may also include a data store to store the process integration scenarios. The system and method may further provide for the application to connect to an external application store to update the process integration scenarios, or connect to a database in a back-end system with stored scenarios.

### BACKGROUND INFORMATION

Process integration scenarios or business process diagrams are used to visualize the message flow of a collaborative process which is outlined between multiple business partners and their interactions, using a simple and intuitive graphical notation. These business partners can either refer to distinct applications inside a single company or represent separate and different companies. Interactions between each of the business partners are made through the exchange of electronic messages, such as XML or EDI messages. For each cross-component process step, i.e. the exchange of electronic messages, process integration scenarios depict the sender and receiver as well as the sending and receiving interfaces. In scenarios in which the sending and receiving interface are different, messages have to be transformed by separate mappings. Furthermore, a sender and a receiver might use different message protocols. These message protocols have to be transformed to allow for exchange between the sending and receiving interfaces. A process integration scenario comprises the information of all the business partners involved, the interfaces, transformation rules, and the message protocols of the collaborative process. Therefore, a process integration scenario serves as an overarching implementation of a collaborative process.

Currently, there are many restrictions in the usage of process integration scenarios with regards to devices, presentation layers, licenses, and content prerequisites. For storing and visualizing collaborative processes, industry standard languages have been introduced, including, for example, Business Process Execution Language for Webservices (“WS-BPEL”). For the visualization of such scenarios using this language, a WS-BPEL-capable reader is necessary, such as an enterprise services repository (“ESR”). Since users need a license for installing and using products, an appropriate product license is required even for accessing any existing ESR content, as process integrations scenarios are shipped as ESR content and ESR content software components, as part of products. As a consequence, users need a required product license even if they wish to simply view the process integration scenarios and have no possibility to view and analyze process integration scenarios themselves. Furthermore, not all users have a specific application or device that will allow them to view progress integration scenarios. Even for simply viewing process integration scenarios, users need a computer or laptop with an up-to-date Java runtime environment installed and configured. A large allocation of memory is also needed for these devices because of the requirement to download and store the requisite java libraries. Most of these java libraries are not needed for the purpose of viewing the integration scenarios.

Thus, there remains a need in the art for a system that allows users to view process integration scenarios without current restrictions with regards to devices, presentation layers, licenses, and content. There also remains a need in the art, for a system which provides users with the flexibility to view process integration scenarios on mobile devices.

### SUMMARY

A system and method are described herein that provide for an application implemented on a mobile device that may visualize process integration scenarios on the device. The application may include a parser to translate the metadata written in a given language into graphical elements. The application may also include a data store to store the process integration scenarios. The system and method may further provide for the application to connect to an external application store to acquire new or updated process integration scenarios, or connect to a database in a back-end system with stored scenarios.

In particular, the exemplary embodiments and/or exemplary methods are directed to an apparatus and method for visualizing process integration scenarios. This apparatus and method includes a mobile device that has a user interface to display an application. The application in particular includes a data store that stores the process integration scenarios in a notated language and a parser that translates the process integration scenarios in the notated language to graphical elements. The parser can use libraries of a software development kit.

If the process integration scenarios are to be updated, the application can connect to an external application store to retrieve updated process integration scenarios that are stored there. These updated process integration scenarios are then uploaded to the application. The application store can also provide an updated version of the application which can be downloaded to the mobile device.

The process integration scenarios can also be updated by connecting to a back-end computer system or network to retrieve updated process integration scenarios. In this case, the updated process integration scenarios can be stored in a database in the back-end system in a specific language. When the updated process integration scenarios are retrieved, the scenarios are translated to a data protocol by a gateway. The application on the mobile device connects to a gateway through a platform that provides a secured connection for connectivity. The application can also include client libraries which enable the secured connection of the application to the platform.

Metadata of the process integration scenarios can also be stored locally in the data store of the application. This may allow for viewing process integration scenarios without having to connect to an external application store or a back-end system.

### BRIEF DESCRIPTION OF THE DRAWINGS

FIG. 1 is a diagram of process integration scenarios on an application executed on a computer according to an embodiment.

FIG. 2 is a diagram of process integration scenarios visualized on an application displayed on a mobile device according to an embodiment.

FIG. 3 is a diagram of process integration scenarios visualized on an application displayed on a mobile device through an offline connectivity according to an embodiment.

FIG. 4 is a diagram of updating process integration scenarios on an application displayed on a mobile device through an online connectivity according to an embodiment.

FIG. 5 is a flow diagram of process for visualizing process integration scenarios on an application on a mobile device according to an embodiment.

FIG. 6 is an example user interface for displaying process integration scenarios on a mobile device according to an embodiment.

FIG. 7 is an example user interface for displaying a performed action of a process integration scenario on a mobile device according to an embodiment.

### DETAILED DESCRIPTION

The subject matter will now be described in detail for specific preferred embodiments, it being understood that these embodiments are intended only as illustrative examples and is not to be limited thereto these embodiments.

Traditionally, the viewing of process integration scenarios was limited by the viewing device, presentation layer, licenses, and content, which put restrictions on access by a user. Example embodiments provide a mobile application implemented on a mobile device which allow for visualizing process integration scenarios on the mobile device. The mobile application includes a parser to translate the metadata written in a given language into graphical elements. The mobile application also includes a data store to store the process integration scenarios. The system and method further provide the mobile application connecting to an application store to update the process integration scenarios using an offline approach, or connected to a database with stored scenarios using an online approach.

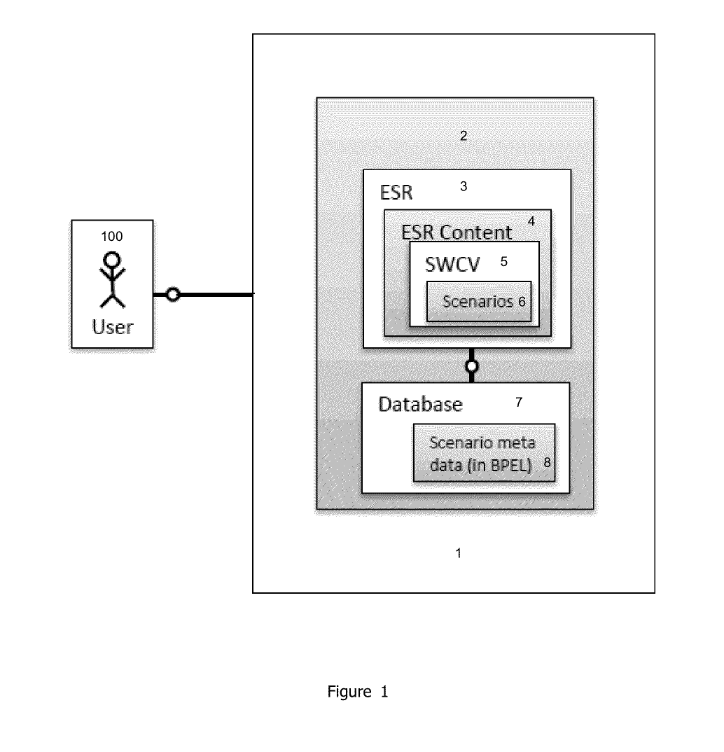

FIG. 1 illustrates a diagram of process integration scenarios on an application executed on a computer according to an embodiment. A user 100 may connect to a computer application 2 that may be executed on a user terminal 1. User terminal 1 may be embodied, for example, as a desktop or laptop or workstation device. Program 2 may be executed by one or more processors, which may be implemented using any conventional processing circuit and device or combination thereof, e.g., a central processing unit (CPU) of a personal computer or other workstation processor, to execute code provided, e.g., on a hardware computer-readable storage medium including any conventional memory device, to run program 2. The memory device may include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape. User terminal 1 may connect to a server to access program 2. Such a server may be implemented remotely using processing circuits or devices or combinations thereof.

Computer application 2 may include an enterprise services repository 3 and a database 7. Repository 3 may be used to store various ESR content 4. This content 4 may include software component versions 5 (“SWCV”) that include process integration scenarios 6. The process integration scenarios 6 may be developed in repository 3 as an ESR content 4 object type. The process integration scenarios 6 may be bundled with other ESR content 4 object types as software component versions in SWCV 5. These scenarios 6 may be packaged and shipped within the SWCV 5.

Computer application 2 may also include a database 7. Database 7 may be connected to repository 3. Database 7 may store metadata 8 for the process integration scenarios 6. Metadata 8 may be written in a business process execution language. Metadata 8 may be stored in database 7 similar to the storage of other ESR Content 4 object types.

Computer application 2 may be displayed on a user interface of user terminal 1 using, for example, a web browser to visualize the objects. In an example embodiment, this user interface may correspond to java based technology that is similarly used for repository 3.

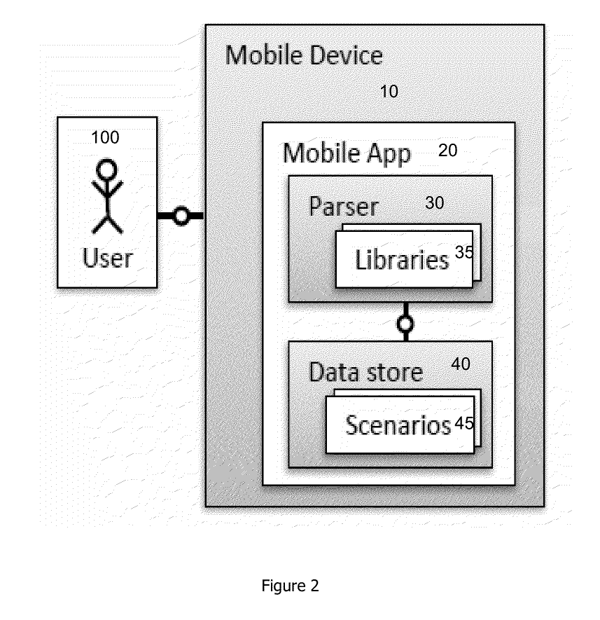

FIG. 2 illustrates a diagram of displaying process integration scenarios on an application on a mobile device according to an embodiment. A user 100 may connect to a mobile device 10 to access an application 20. Mobile device 10 may be embodied, for example, as a tablet, personal digital assistant (PDA), television set-top Internet appliance, mobile telephone, smart phone, iPod™, iPhone™, iPad™, etc., or as a combination of one or more thereof, or other comparable device.

Mobile device 10 may display application 20 in a user interface. In an embodiment, application 20 may be a mobile application specifically configured for the mobile device 10. In another embodiment, the user interface may be based on a java based swing client. In an alternate embodiment, the user interface may be embedded in a web browser of mobile device 10. In an alternate embodiment, the user interface may be an Eclipse based interface.

Application 20 may include a parser 30 and a data store 40. Parser 30 may use libraries 35 pertaining to the software development kit. Parser 30 may be used by application 20 to transform process integration scenario metadata into graphical elements. This metadata may be stored in an industry standard language such as WS-BPEL or any comparable language. Notation from the metadata of the WS-BPEL or language file may be transformed by the parser 30 into graphical elements of the process integration scenarios on the screen of mobile device 10.

Functionality for the parser 30 may be provided by the software development kit (“SDK”) libraries 35. In an embodiment, a parser 30 may be developed that is universal for all mobile devices 10. In an alternate embodiment, a specific parser may be developed for a specific operating system or device. In this embodiment, a parser may be specifically be developed, for example, for an Android-based device, a Blackberry™ device, or an iOS-based device such as an iPhone™ or iPad™. This may be enabled, as each operating system may require its own unique SDK library. In an embodiment, multiple parsers may be developed and implemented, with each parser compatible to a different device or operating system.

Application may include a data store 40. This data store 40 may store process integration scenarios 45 that may be stored on an industry standard language, such as WS-BPEL, on the mobile device 10. Parser 30 may retrieve the WS-BPEL notated process integration scenarios 45 from data store 40 and translation the scenarios 45 into graphical elements of the process integration scenarios.

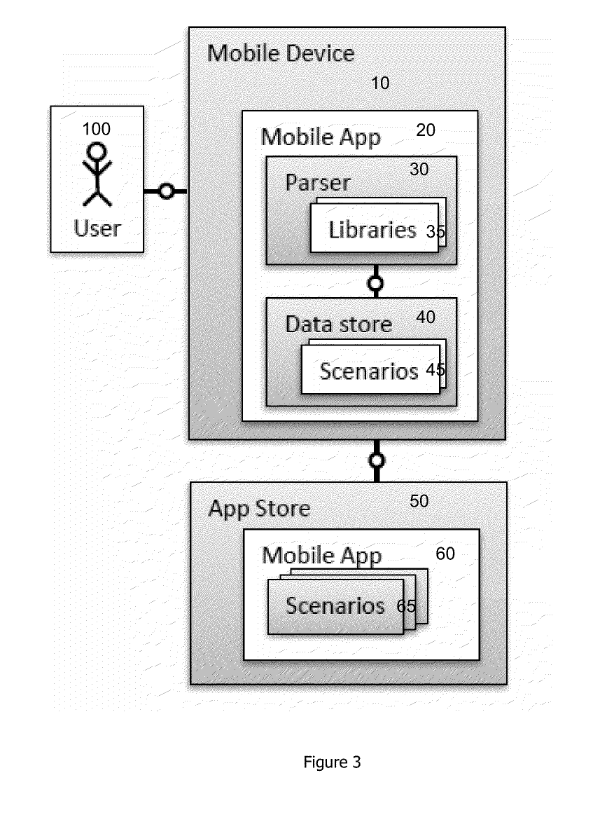

In order to download new or updated process integration scenarios, the mobile application may update the scenarios through an offline or online approach. FIG. 3 illustrates a diagram of a process for updating process integration scenarios on an application displayed on the mobile device through offline connectivity according to an embodiment. An offline connectivity as illustrated in FIG. 3 may also be made to update the latest version of the application 20.

A user 100 may access application 20 on mobile device 10. Application 20 may include a parser 30 and a data store 40. Parser 30 may use SDK libraries 35 and transform process integration scenario 45 that are retrieved from data store 40 into graphical elements of the process integration scenarios. When process integration scenarios 45 are to be updated, application 20 may connect to application store 50. This connection may be made outside of an internal intranet.

Application store 50 may contain the latest version 60 of the application 20. Application store 50 may also contain new or updated process integration scenarios 65. When mobile device 10 connects to application store 50, the latest version 60 of the application and the updated scenarios 65 may be uploaded onto the mobile device. Latest versions of the application and new or updated scenarios may be uploaded to the application store 50. In an embodiment, there may multiple application stores. In this embodiment, there may be a separate application store for each platform that supports application 20, such as, for example, an Apple Store™ or Blackberry Store™. Each of these application stores may contain a different version of the application. In an alternate embodiment, scenarios may be provided on an internal portal such as an external website for one of the business partners.

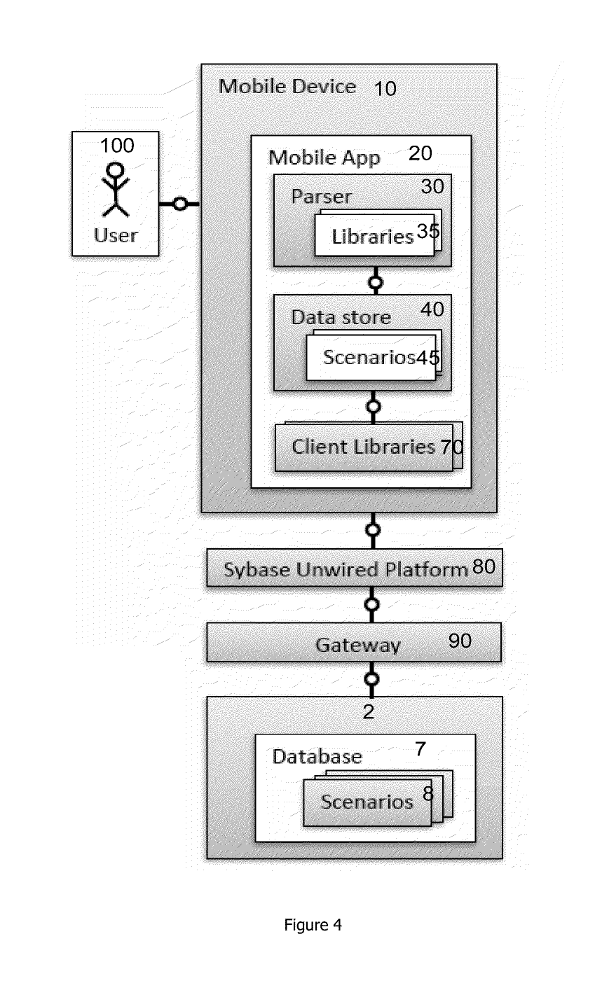

FIG. 4 illustrates a diagram of a process for updating process integration scenarios on an application displayed on the mobile device through online connectivity according to an embodiment. A user 100 may access application 20 on mobile device 10. Application 20 may include a parser 30 and a data store 40. Parser 30 may use SDK libraries 35 and transform process integration scenario 45 that are retrieved from data store 40 into graphical elements of the process integration scenarios. Mobile device 10 may also contain client libraries 70, such as, for example, Sybase client libraries, which may allow for connecting a mobile device to a back-end computer system and/or network.

When process integration scenarios 45 are to be updated, application 20 may connect to a back-end system and/or network, through, for example a Sybase Unwired Platform 80. Platform 80 may connect to the mobile device 10 via the client libraries 70. Platform 80 may provide administrative functions such as providing security keys that may enable mobile device 10 to connect to a back-end system through business gateway 90.

Metadata of process integration scenarios may be shipped to users independent from an actual product, thus not requiring a license to access the metadata. Metadata of any updated process integration scenarios may be stored on a database on the back-end of a computer or workstation system and/or network. The updated process integration scenarios 8 may be stored in a database 7. The updated process integration scenarios 8 may be self-made and uploaded to database 7. When the integration process scenarios 8 are transmitted from database 7, gateway 90 may transform the internal data protocol into a necessary data format, such as, for example, OData format. The scenarios 8 may be transmitted to the device in the OData format through platform 80.

Online connectivity may not be used to download the application 20 or update the mobile device 10 with the latest version 60 of the application. To download the application 20 or update the mobile device 10 with the latest version 60 of the application, mobile device 10 may be connected to an application store 50.

In an embodiment, a combination of offline and online connectivity may be used. In this embodiment, process integration scenarios 8 may be downloaded from a back-end system and/or network using an online connectivity approach, but the metadata of the process integration scenarios 8 may be stored locally in the data store 40 of the application 20. In this embodiment, even if no online connectivity may be made to the back-end system and/or network, the latest updated process integration scenarios may still be visualized.

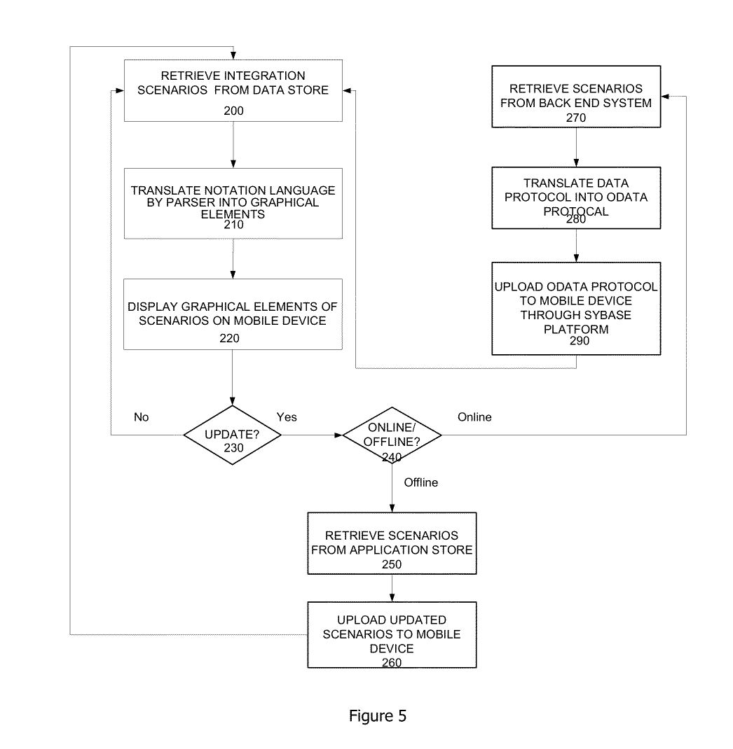

FIG. 5 illustrates a flow diagram of process for visualizing process integration scenarios on an application of a mobile device during operation according to an embodiment. In step 200, process integration scenarios 45 that are stored in data store 40 may be retrieved from the data store 40 by application 20. These process integration scenarios 45 may be in an industry standard language such as, for example, WS-BPEL. In step 210, the parser 30 may translate the WS-BPEL or other language files using definitions from SDK libraries. Parser 30 may translate the WS-BPEL notation into graphical elements. The system and method may then move to step 220. In step 220, the graphical elements produced by parser 30 may be displayed on application 20 on the mobile device 10.

Once the graphical elements of the process integration scenarios have been displayed on the mobile device in step 220, the system and method may proceed back to step 200, where during a later time, additional process integration scenarios may be retrieved from data store 40.

The system and method may make a determination that the process integration scenarios must be updated. This determination may take place in step 230. If it is determined that an update to the process integration scenarios is necessary, the system and method may move to step 240. In step 240, it may be determined by application 20 whether to update the process integration scenarios using online or offline connectivity. This determination may be made, for example, based on a user's current access to an intraweb of a back-end system and/or network, and an ability to make a connection to that system and/or network.

If it is determined in step 240 that an offline connection is to be made by mobile device 10, application 20 may connect to application store 50. In step 250, the updated process integration scenarios 65 may be retrieved from application store 50. In step 260, the system and method may upload the updated process integration scenarios 65 to mobile device 10.

If it is determined in step 240 that an online connection is to be made by mobile device 10, the system and method may move to step 270. In step 270, application 20 may connect to a workstation of a back-end system and/or network through a platform 80 and gateway. The updated process integration scenarios 8 may be retrieved from a database 7 on a device operating on the back-end system and/or network. In step 280, the retrieved process integration scenarios may be translated from the data protocol of program 2 to a protocol, such as OData, that is supported by application 20. In step 200, the system and method may upload the translated protocol to mobile device 10 through a platform 80.

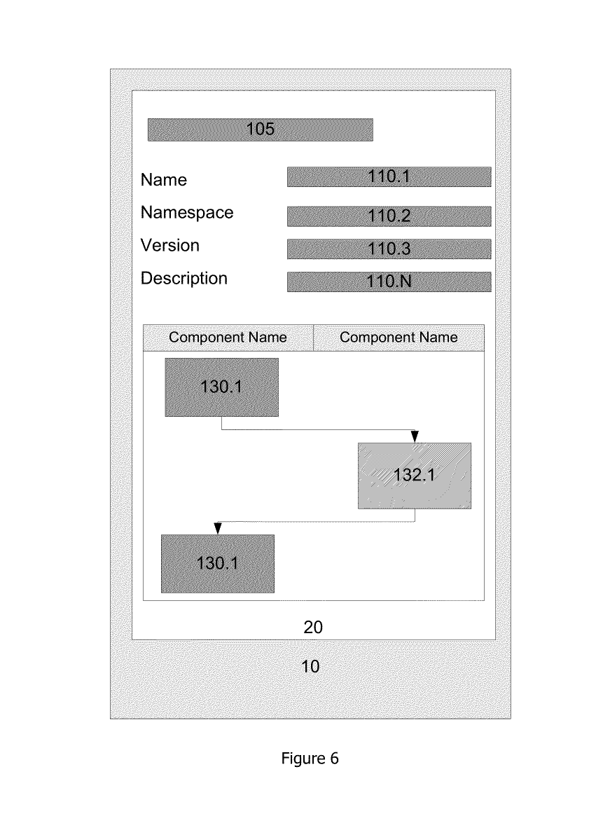

FIG. 6 illustrates an example of a user interface for displaying process integration scenarios on a mobile device according to an embodiment. The user interface of application 20 may be displayed on mobile device 10. The interface may display a window with information pertaining to a given process integration scenario. The interface of application 20 may include a title field 105 for application 20.

A plurality of input fields 110.1-110.N may be displayed below title field 105 on the interface. Each of these input fields may be displayed adjacent to input field headers. In the example embodiment illustrated in FIG. 6, these input field headers may include but are not restricted to “Name”, “Namespace”, “Version”, and “Description”. Any interface for application 20 may include corresponding input fields and input fielders beyond those depicted in FIG. 6.

Values may be entered for each one of input fields 110.1-110.N. Input field 110.1 may contain the value of the name of a specific process integration scenario that is to be displayed. Conversely, input field 110.2 may contain information as to the physical location of the process integration scenario metadata for the specific process integration scenario in input field 110.1. Input field 110.3 may, for example, include information corresponding to the version number of the process integration scenario and input field 110.N may contain descriptive information about the process integration scenario that is being graphically depicted by application 20.

Application 20 may display process integration scenario 110.1 in a viewing pane containing action boxes 130.1, 130.2, and 132.1. These action boxes may depict the interaction between multiple actors, such as business partners, which fully depicts process integration scenario 110.1.

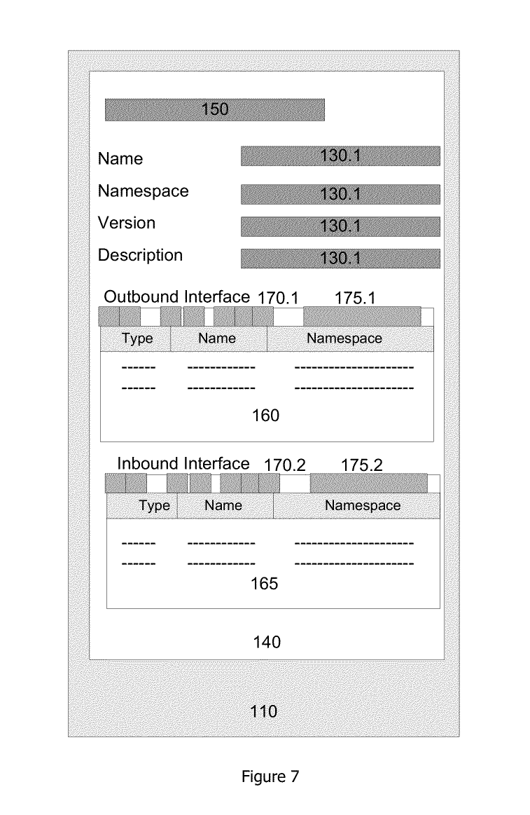

FIG. 7 illustrates an example of a user interface displaying a process step of a process integration scenario on a mobile device according to an embodiment. If a user selects a action box, such as, for example, action box 130.1 in FIG. 6, application 20 may display the selected process step on the interface, as illustrated in FIG. 7. The interface may display information pertaining to a selected process step of a process integration scenario. The interface of application 20 may include a title field 150 for the selected process step.

A plurality of input fields may be displayed below title field 150 on the interface. Each of these input fields may be displayed adjacent to input field headers. In the example embodiment illustrated in FIG. 7, these input field headers may include but are not restricted to “Name”, “Namespace”, “Version”, and “Description”. The values corresponding to these input field headers may correspond to information about the selected process step 130.1, for example the name of the process step, the physical location of the metadata, and the version and corresponding description.

The interface may include viewing panes 160 and 165. Viewing pane 160 may correspond to a list of outbound or sending interfaces, for the selected process integration scenario. Conversely, viewing pane 165 may correspond to a list of inbound or receiving interfaces, for the process integration scenario.

Viewing pane 160 may list the outbound interfaces. In the embodiment illustrated in FIG. 7, viewing pane 160 may include headers corresponding to “Title”, “Name”, and “Namespace” of the sending interfaces. These headers may be used to arrange the listed interfaces. Viewing pane 160 may include a menu 170.1 with a plurality of buttons that may perform various operations on the list of interfaces. Viewing pane 160 may also include a search field 175.1 which may allow for searching through the listed interfaces in viewing pane 160.

Viewing pane 165 may list the process inbound interfaces. In the embodiment illustrated in FIG. 7, viewing pane 165 may include headers corresponding to “Title”, “Name”, and “Namespace” of the receiving interfaces. These headers may be used to arrange the listed interfaces in viewing pane 165. Viewing pane 165 may include a menu 170.2 with a plurality of buttons that may perform various operations on the list of interfaces. Viewing pane 165 may also include a search field 175.2 which may allow for searching through the listed interfaces in viewing pane 165.

Several embodiments are specifically illustrated and/or described herein. However, it will be appreciated that modifications and variations are covered by the above teachings and within the purview of the appended claims without departing from the spirit and intended scope of the matter above.

What is claimed is:

1. An apparatus for visualizing process integration scenarios on a mobile device, the apparatus comprising:
an application displayed on a user interface of the mobile device, the application including:
a data store that stores the process integration scenarios in a notated language; and
at least one parser that translates the process integration scenarios in the notated language to graphical elements.

2. The apparatus according to claim 1, wherein the application connects to an external application store to retrieve new or updated process integration scenarios.

3. The apparatus according to claim 2, wherein the new or updated process integration scenarios are uploaded to the application.

4. The apparatus according to claim 2, wherein the application connects to the external application store to download an initial or updated version of the application.

5. The apparatus according to claim 1, wherein the application connects to a back-end computer system or network to retrieve new or updated process integration scenarios.

6. The apparatus according to claim 5, wherein the new or updated process integration scenarios are written in the notated language that is translated to a different data protocol by a gateway.

7. The apparatus according to claim 6, further comprising:
a platform configured to connect the application to the gateway through a secured connection.

8. The apparatus according to claim 7, wherein the application include client libraries to enable the secured connection of the application to the platform.

9. The apparatus according to claim 1, wherein metadata of the process integration scenarios are stored locally in the data store of the application.

10. A method for visualizing process integration scenarios on a mobile device, the method comprising:
retrieving the process integration scenarios from a data store of an application displayed on the mobile device, the process integration scenarios being stored in a notated language; and
translating the process integration scenarios in the notated language to graphical elements by at least one parser of the application.

11. The method according to claim 10, further comprising:
connecting to an external application store to retrieve new or updated process integration scenarios.

12. The method according to claim 11, further comprising:
uploading the new or updated process integration scenarios to the application.

13. The method according to claim 11, further comprising:
connecting to the external application store to download an initial or updated version of the application.

14. The method according to claim 10, further comprising:
connecting to a back-end computer system or network to retrieve new or updated process integration scenarios.

15. The method according to claim 14, further comprising:
translating the new or updated process integration scenarios from the notated language to a different data protocol by a gateway.

16. The method according to claim 15, further comprising:
securely connecting the application to the gateway through a platform using client libraries.

17. The method according to claim 10, wherein metadata of the process integration scenarios are stored locally in the data store of the application.

18. A mobile device having a mobile application stored thereon to visualize process integration scenarios, the mobile device comprising:
an arrangement providing the following:
retrieving the process integration scenarios from a data store of the mobile application, the process integration scenarios being stored in a notated language;
translating the process integration scenarios in the notated language to graphical elements by at least one parser of the mobile application; and
displaying the graphical elements on the mobile application.

19. The mobile device according to claim 18, wherein the arrangement connects to an external application store or a back-end system to retrieve new or updated process integration scenarios.

20. A system for running a mobile application to visualize process integration scenarios on a mobile device, the system comprising:
a user interface;
a data store that stores the process integration scenarios in a business process execution language for webservices;
at least one parser that translates the process integration scenarios in the business process execution language for webservices to graphical elements, the graphical elements being displayed on the user interface of the mobile device;
an application store to retrieve new or updated process integration scenarios to the mobile device through offline connectivity; and
a back-end computer system or network to retrieve the new or the updated process integration scenarios through online connectivity.

21. A method for providing visualized process integration scenarios on mobile devices, the method comprising:
uploading an initial or updated application to an application store, the initial or updated application being downloadable to the mobile devices, the initial or updated application configured to:
retrieve process integration scenarios stored in a notated language in an internal data store of the initial application or updated application; and
translate the process integration scenarios to graphical elements by at least one parser of the initial or updated application.

22. A method for providing visualized process integration scenarios on mobile devices, the method comprising:
uploading new or updated process integration scenarios to an application store or back-end system,
wherein the new or updated process integrations scenarios are stored in a notated language and are downloadable to an application on the mobile devices, the application configured to translate the new or updated process integration scenarios to graphical elements by at least one parser of the application.

23. An apparatus for visualizing process integration scenarios, the apparatus comprising:
a mobile device; and
an application displayed on a user interface of the mobile device, the application including:
a data store that stores the process integration scenarios in a notated language; and
at least one parser that translates the process integration scenarios in the notated language to graphical elements.
